(19) United States
(12) Patent Application Publication
(10) Pub. No.: US 2023/0302466 A1
(43) Pub. Date: Sep. 28, 2023

(54) SEPARATOR INSERT AND SEPARATOR

(71) Applicant: GEA WESTFALIA SEPARATOR GROUP GMBH, Oelde (DE)

(72) Inventors: Rüdiger GÖHMANN, Oelde (DE); Kai HELMRICH, Drensteinfurt (DE); Kathrin QUITER, Drensteinfurt (DE); Andreas SCHULZ, Beckum (DE)

(21) Appl. No.: 18/021,067

(22) PCT Filed: Aug. 5, 2021
(86) PCT No.: PCT/EP2021/071878

§ 371 Date: Feb. 13, 2023

(30) Foreign Application Priority Data
Aug. 14, 2020 (DE) 10 2020 121 422.7

(51) Int. Cl. B04B 7/04; B04B 11/02; B04B 9/12; B04B 1/08

(52) U.S. Cl. CPC B04B 7/04; B04B 11/02; B04B 9/12; B04B 1/08

(57) ABSTRACT

A separator insert includes a housing that is stationary during operation and which is a container that is closed apart from a number of openings. A rotor is arranged within the housing and is rotatable about an axis of rotation. The separator insert includes a drum with openings. At least two rotor units for magnetic bearing units are arranged at two axially spaced apart points on the rotor with the drum, that hold the rotor in a suspended state and that can rotate the rotor.

### BACKGROUND AND SUMMARY OF THE INVENTION

Exemplary embodiments of the invention relate to a separator insert for a separator and to a separator comprising such a separator insert. Separators as defined in this document are used to separate a flowable suspension as a starting product in the centrifugal field into phases of different density. Steam sterilization of the separators used is necessary for a wide variety of applications. A relatively “small” steam-sterilizable separator with disk stack introduced to the market via the applicant is the separator “CSC 6” with 6000 m² equivalent clarifying area. However, in some situations, such as in the laboratory, this machine is still relatively large. The known separators with disk stack available on the market are driven by means of a spindle, which in turn is driven by a motor directly or via a gearbox. In addition, the known machines are made of stainless steel. For these reasons, filters are currently used very frequently in laboratories instead of centrifugal separators. In the case of a separator with a disk stack and with disposable plastic components (single-use technology—single use of pre-qualified plastic parts), steam sterilization (SIP—Sterilization In Place) would not be necessary. It could be particularly suitable for use in biotechnology.

WO 2014/000829 A1 discloses a separator for separating a flowable product into different phases, which has a rotatable drum with a drum lower part and a drum upper part and a means arranged in the drum for processing a suspension in the centrifugal field of solids or for separating a heavy solid-like phase from a lighter phase in the centrifugal field, wherein one, several or all of the following elements consist of plastic or a plastic composite material: the drum lower part, the drum upper part, the means for clarifying. In this way it is possible to design a part of the drum or preferably even the entire drum—preferably together with the inlet and outlet systems or areas—for single use, which is of particular interest and advantage with regard to the processing of pharmaceutical products such as fermentation broths or the like, since after operation for the processing of a corresponding product batch in preferably continuous operation during the processing of the product batch, no cleaning of the product-contacting parts of the drum has to be carried out, but the drum as a whole can be replaced. Especially from a hygienic point of view this separator is thus very advantageous. In order to achieve a physical separation between this disposable drum and the drive, a contact-free coupling between the drive and the drum is advantageous.

A further development is shown in DE 10 2017 128 027, in which the bearing devices are designed as magnetic bearings and one of the magnetic bearing devices is preferably also used as a drive device for rotating the drum, which is held in suspension during operation. This eliminates the need for mechanical components for rotating and supporting the drum, which favors the design as a separator with a separator insert for single use, since replacement of this separator insert is very easy to handle. These advantages are also exploited by the present invention.

Against this background, exemplary embodiments of the invention are directed to a generic separator insert, which can be used or designed as a one-way element, in such a way that the separation process can be better controlled.

According to embodiments of the invention, there is a separator insert for a separator which is designed for separating a flowable suspension in a centrifugal field into at least two flowable phases of different density and, which comprises the following:
a) a housing which is stationary in operation and which is designed in the manner of a container that is closed apart from a plurality of openings, wherein these openings are designed at least as follows: as an opening for the inflow of an inflowing suspension, formed on a first axial boundary wall of the housing, and as two openings for the discharge of respective flowable phases of different density in an outer casing of the housing and a second axial boundary wall of the housing or on the first and the second axial boundary wall of the housing,
b) a rotor arranged within the housing and which can be rotated about an axis of rotation, and having a drum which has openings,
c) wherein a feed pipe, which does not rotate during operation, for feeding the suspension to be processed into the drum extends into one of the openings of the drum at a first of its two axial ends and does not touch the drum, and wherein at least one outlet for a first of the flowable phases from the drum is in the form of a peeling disk which does not rotate during operation and which has a discharge pipe which is guided out of the drum at the opposite second axial end of the drum,
d) wherein a separating means is arranged in the drum, and
e) wherein at least two rotor units for magnetic bearing devices are arranged at two axially spaced-apart locations of the rotor with the drum, with which the rotor with the drum can be held in a suspended state, can be rotatably mounted and can be made to rotate within the housing during operation.

This design makes it possible to control the separation process particularly well.

“In operation” means during a or the centrifugal processing when the rotor is turning.

It is preferred, because it is simple and practical, that the rotor units are located at both axial ends of the drum, and that two corresponding stator units are formed on the frame of the separator. In this way, magnetic bearing devices are formed at both axial ends of the drum.

Preferably, the openings of the drum are thus functionally associated with the openings of the housing from a).

In this context, at least one of the two magnetic bearing devices preferably also represents the rotary drive for the drum, wherein this drive is also suitable for driving the drum at freely adjustable speeds or in a freely selectable direction of rotation. Preferably, it may be provided that one or both magnetic bearing devices can act as radial and axial bearings and hold the rotor in a suspended state in the container at a distance from it during operation.

It may be further preferably provided that the separator insert forms a pre-assembled, interchangeable unit for insertion into stator units on the frame of the separator. In interaction, the rotor and stator units form magnetic bearing devices. With these, the drum can be axially and radially supported and held in suspension.

According to a first advantageous and constructively particularly easy to implement variant, it is additionally provided that a further opening of the drum is designed as a free radial outlet for a second of the flowable phases from the drum into the housing, from which it can be discharged. For this purpose, it can be further advantageously and simply provided that the free outlet is associated with a trapping ring chamber of the housing, which has a discharge from the housing.

According to another advantageous variant, which is particularly easy to implement in terms of design, however, it can also be provided in a supplementary manner that a further opening in the drum for discharging the further flowable phases from the drum is designed as a second peeling disk. It can then be advantageously provided that the second peeling disk has a discharge pipe formed coaxially with the feed pipe and is guided coaxially with the latter out of the drum and through the opening in the first axial boundary wall of the housing.

In order to control the separation process, i.e., to be able to control or regulate it, it can also be provided that a regulating valve is connected downstream of the first peeling disk and/or the second peeling disk on the flow side—or, optionally, on the discharge side—which can be controlled by a control device.

It may be further preferably provided that a separating means, in particular a disk stack, is arranged in the drum and that the first peeling disk is arranged in the drum below the distributor and below the disk stack in a structurally space-saving and simple manner, i.e., in an area that is otherwise often required for fastening a drive spindle, which is not required here.

It is preferred—since it is simple and safe in terms of design—that the rotor units for the magnetic bearing devices are arranged at the two axial ends of the drum and that the feed pipe and the discharge pipe of the first peeling disk each pass axially through one of these two rotor units.

It is particularly advantageous and practical that the separator insert is designed as a pre-assembled unit. In particular, it can also be provided that all elements of this insert coming into contact with the product are made of plastic or another non-magnetic material, wherein it can be replaced as a whole and can be completely disposed of after use. Cleaning and, optionally, steam sterilization of the separator insert are thus no longer necessary.

The respective bearing arrangement, which in addition to a radial bearing arrangement also provides an axial bearing arrangement for the drum and/or a rotary drive, can act permanently and/or electromagnetically.

At the outer circumference, the feed pipe or a peeling disk shaft surrounding it is preferably inserted in the housing in a sealed manner or is formed integrally with it.

The drum can be of single-conical or double-conical design. It may additionally or alternatively also have one or more cylindrical sections. It may further be composed of several parts, in particular an upper part and a lower part, wherein these parts are preferably connected to each other (e.g., by gluing or welding) after the installation of internal components and their assembly. Similarly, the housing can be composed of several parts, in particular an upper part and a lower part, wherein these parts are preferably connected to each other (e.g., by gluing or welding) after the installation of internal components—in particular the rotor—and their assembly.

The discharges can have nozzles on the outside of the housing, which are sealed on the outer circumference of the housing, so that hoses or the like can be easily connected in this way. The hoses can also be pre-assembled on the nozzles so that they are completely and, optionally, sealed in a germ-free manner. The nozzles can extend, for example, radially, tangentially, or obliquely to the radial direction.

These separators are suitable for operation at variable, even relatively high speeds. In addition, it can also be used well for one-off processing—for example, for centrifugal separation of a product batch of a flowable fermentation broth as a suspension—from e.g., 100 L to several thousand, e.g., 4000 L—into different phases—and then disposed of. Here, a particular advantage is that all product-contacting components of the separator can be installed, operated, and subsequently disposed of as a prefabricated and already aseptic unit. This prefabricated unit consists at least of the rotor with the drum, the separating disks, the feed distributor, and the rotor magnets or rotor units, as well as the housing with the inlets and outlets. Furthermore, the unit can also contain supply opening and discharge lines (e.g., hoses) as well as measuring equipment or other components that come into contact with the product, which are intended for single use and are disposed of together with the separator unit after use.

A further advantage is that, in addition to a lower thrust bearing in the first vertical alignment of the axis of rotation, a further thrust bearing—e.g., at an opposite end of the drum or possibly also in the drum—is provided. This is because this allows the axis of rotation of the drum to be arranged vertically, but alternatively also advantageously inclined from the vertical. Any arrangement of the axis of rotation is possible. The axis of rotation can thus, for example, be inclined from the vertical at an angle of 30-60°, for example 45°, or it can also be aligned horizontally, i.e., aligned inclined by 90° to the vertical. Furthermore, it is also possible to rotate the entire arrangement by 180°, so that the supply opening is arranged at the bottom and the conical separating disks open upwards, without this causing storage problems for the drum.

Insofar as “a first vertical orientation of the axis of rotation” is considered here or below, this means that the position of the elements of the centrifuge in a vertical orientation of the axis of rotation as described can be realized or is realized. Practically, however, the axis of rotation can then also be oriented obliquely to the vertical orientation. Then, preferably, the discharge for the phases LP, HP, is placed in each case at a vertically lowest position of the respective trapping ring chambers.

It is further advantageous if one of the bearing and/or drive units is designed to radially support and rotate the drum in a first vertical orientation at its lower end.

Finally, it can be advantageously provided that the housing has only the openings for feed pipes and discharges and is otherwise hermetically sealed. For this purpose, it can be provided that the feed pipes and the discharges project outwardly from the housing in the manner of nozzles, wherein these nozzles are connected to the housing in a sealed manner or are formed integrally therewith.

The invention also provides a separator having a frame and an interchangeable separator insert according to one of the claims related thereto.

This facilitates the creation of a separator having a disposable module with disposable “drum” and “housing” components, whereas at least the frame and parts of the bearing and drive assembly can be reusable.

The invention enables the manufacture of a separator in which a disposable separator insert can be used, which is preferably designed in such a way that all components in contact with the product are made of plastic or other non-magnetic materials which can be disposed of after single use. Cleaning after use is thus not necessary. The machine and its operation can thus be made significantly less expensive. Magnets can optionally be recycled.

After its manufacture, the entire separator insert is provided as a sealed unit into which no impurities can enter. For this purpose, the nozzles can be sealed and detachably closed. Thus, hose sections can be arranged on the nozzles having openable and closable connectors with which the separator module or, in this case, the separator insert can be connected to further elements of the feed and discharge system such as bags or tanks or hose or pipelines.

It is simple and safe if the bearing devices are mounted on the frame at a distance from each other, between which the separator insert can be inserted in a rotationally fixed manner.

For this purpose, it may be further provided that the relative distance of the holders on the console is adjustable in order to be able to change the separator insert.

It can further be provided that the separator insert can be fastened to the frame in a form-fitting and/or force-fitting manner so as to prevent rotation. According to a particularly simple variant, the housing and the holders have corresponding interlocking elements to hold the housing against rotation on the frame or stator units.

The position of these corresponding interlocking elements also defines the functionally required position of the stator units and the rotor units relative to each other. This relates in particular to the precise centering of the respective units lying coaxially in one another. Optionally, a holding force (from above and below) can also be exerted on the housing in the axial direction by the holders in order to optionally hold it frictionally.

It can also be provided if at least one control device is provided with which the amount of recirculation of the light or the heavy phase—in particular using one or more results of measurements with the measuring device—can be controlled or regulated.

### BRIEF DESCRIPTION OF THE DRAWING FIGURES

In the following, the invention is described in more detail by means of exemplary embodiments with reference to the drawing, wherein further advantageous variants and designs are also discussed. It should be emphasized that the exemplary embodiments discussed below are not intended to describe the invention conclusively, but that variants and equivalents not shown are also feasible and are covered by the claims, wherein:

FIG. 1: shows a schematic, sectional view of a first exchangeable separator insert of a separator together with a schematic view of a feed and discharge system and a control unit of the separator;

FIG. 2: shows a schematic, sectional view of a second exchangeable separator insert of a separator together with a schematic view of a feed and discharge system and a control unit of the separator;

FIG. 3: shows a schematic representation of a separator with a reusable frame and an exchangeable separator insert, the latter here in the manner of FIG. 1, with hose sections arranged thereon;

FIG. 4: shows a perspective view of the exchangeable separator insert of FIGS. 1 and 3 with hose sections arranged thereon; and

FIG. 5: shows a perspective view of a second variant of an exchangeable separator insert in variation of the variant of FIG. 4.

### DETAILED DESCRIPTION

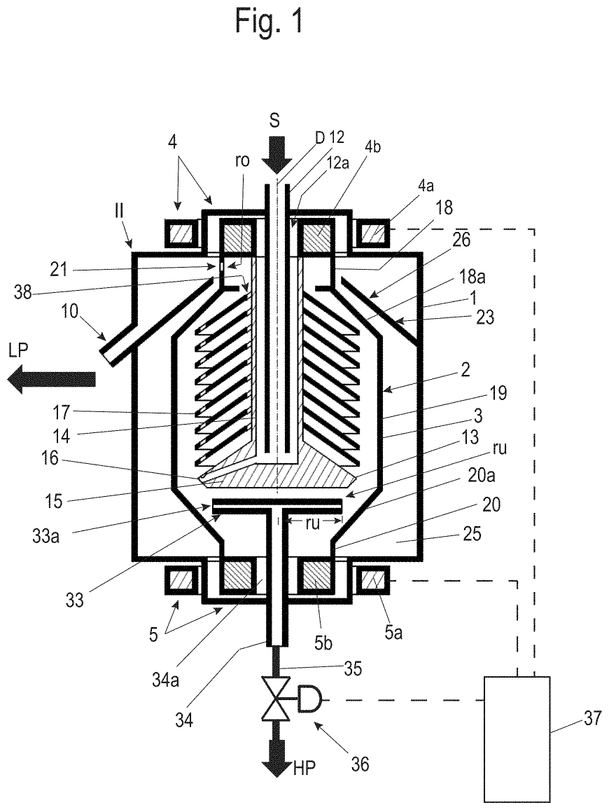

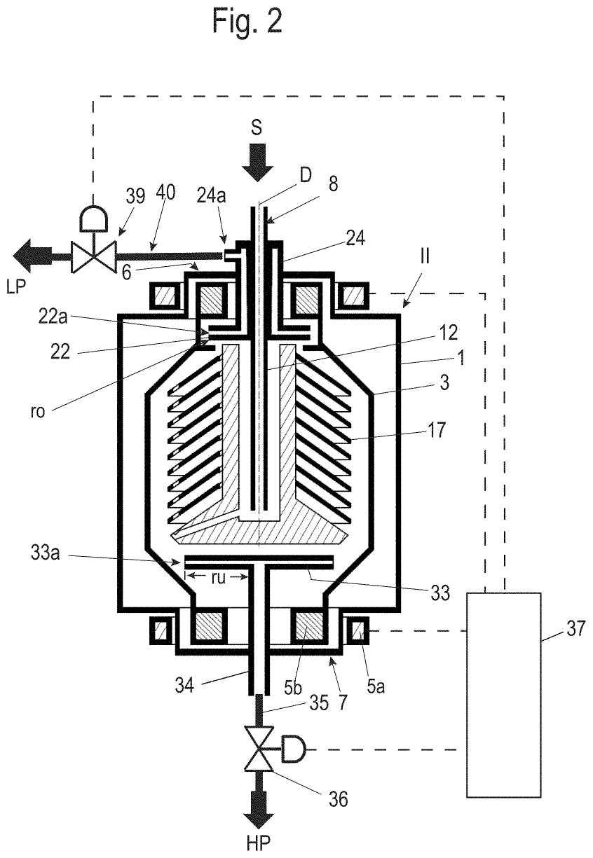

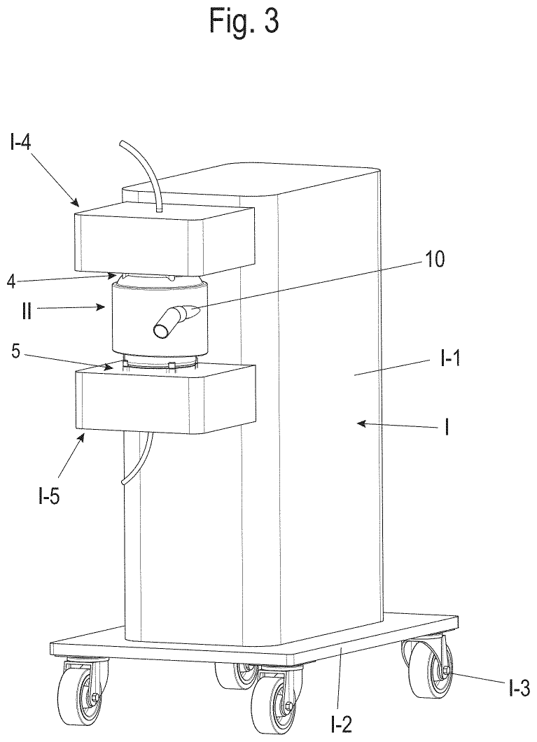

FIG. 3 shows a separator with a reusable frame I and with an exchangeable separator insert II in the manner of FIG. 1 for centrifugal separation of a product—a suspension S—into different dense phases HP, LP. The separator insert could also be designed in the manner of FIG. 2.

The separator insert II is preferably designed as a prefabricated unit. In particular, the separator insert II is designed as a disposable separator insert that can be exchanged or replaced as a whole and is designed as a pre-assembled unit, which is made entirely or predominantly of plastic or plastic composite materials.

The separator insert (which does not include elements 4a and 5a) is shown separately as an example in FIGS. 1 and 2. It can be disposed of after processing of a product batch and exchanged for a new separator insert II.

Such a separator with an easily exchangeable separator insert can be useful and advantageous for processing products for which it can be ruled out with a very high degree of certainty that impurities will be introduced into the product—a flowable suspension or its phases—during centrifugal processing, or for which cleaning and disinfection of the separator would be very costly or not possible at all.

The frame I has a console I-1. This can—but does not have to—be mounted on a carriage I-2 with rollers I-3. Receptacles I-4 and I-5 can be arranged on the console I-1, which serve to accommodate and hold the separator insert II also during operation. Preferably, a first axial end of the separator insert II projects from below into the upper receptacle I-4 and a lower end of the separator insert II projects from above into the other receptacle I-5.

In the respective receptacles I-4 and I-5, respective stator units 4a, 5a of two drive and magnetic bearing devices 4 and 5 can be arranged. The control and power electronics for this can be arranged in the frame I, e.g., in the console I-1.

Here, these receptacles I-4 and I-5 project laterally from the console I-1 of the frame I. They can be arranged on the console I-1 in a height-adjustable manner.

Corresponding interlocking elements can be formed on the receptacles I-4 and I-5 and on a housing 1 of the separator insert II, which does not rotate during operation, in order to be able to insert the separator insert II into the stator units 4a, 5a in a rotationally fixed manner. The upper and lower stator units 4a, 5a can each have axes that are aligned with one another.

For changing the separator insert II, it can be provided that the two receptacles I-4 and I-5 with the stator units 4a, 5a, are arranged on the frame I-1 so that they can move axially—and here also vertically by way of example—relative to one another, in particular displaceably.

In this case, for example, it can be advantageously provided that the receptacles I-4 and I-5 with the stator units 4a, 5a on the frame I can be moved axially apart and towards each other again in order to change the separator insert II, i.e., in order to be able to remove the old separator insert II from the frame I and exchange it for a new one. For this purpose, it can be further provided that the relative distance of the receptacles I-4 and I-5 with the stator units 4a, 4b of the bearing devices 4, 5 can be adjusted in order to be able to change the separator insert II.

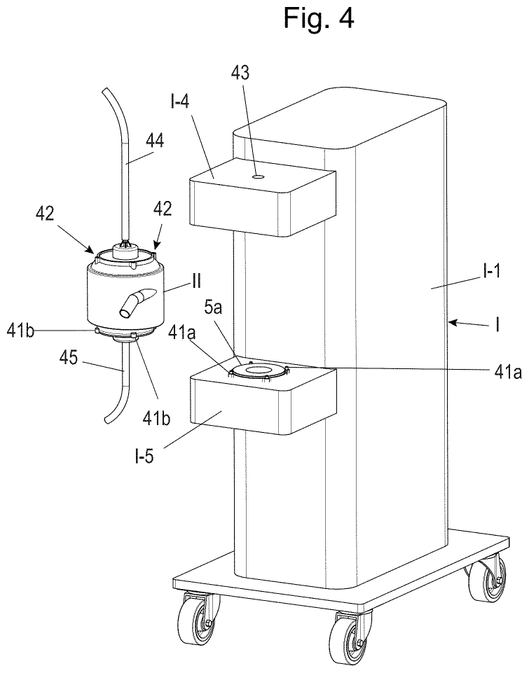

It can further be provided that the separator insert II can be attached to the frame I in a form-fitted and/or force-fitted manner and in a rotationally fixed manner. According to a particularly simple variant, the housing 1 and the stator units 4a, 5a can have corresponding interlocking elements such as projections (e.g., pins) and recesses (e.g., bores) for this purpose, in order to hold the housing 1 on the stator units and thus on the frame I in a rotationally fixed manner. In FIG. 4, corresponding interlocking elements 41 and 42 are arranged in a circumferentially distributed manner in the lower and upper regions of the separator insert II and on the frame. However, it is also possible that only one interlocking element is provided instead of a plurality of interlocking elements in the lower or upper region of the separator insert II and at the corresponding point on the frame I. The corresponding interlocking elements in FIG. 3 and FIG. 4 are pins 41a and recesses 41b. The corresponding interlocking elements can also be formed directly on the frame I. The corresponding interlocking elements can be arranged symmetrically but also asymmetrically to ensure that the separator insert can only be inserted in a single orientation.

In the following, with reference to FIG. 1 and FIG. 2, the structure of preferred separator inserts II is described in more detail, together with the structure of the drive and bearing system of the separator, the control system of the separator and the feed and discharge system of the separator.

According to FIGS. 1 and 2, the separator insert II of the separator has a housing 1 and a rotor 2 inserted into the housing 1 and rotatable relative to the housing 1 during operation. The rotor 2 has an axis of rotation D. This can be aligned vertically, which corresponds to the design of the frame I. However, it can also be oriented differently in space if the frame is also designed accordingly.

The rotor 2 of the separator insert II also has a rotatable drum 3. The rotor 2 is rotatably mounted at two locations axially spaced from one another in the direction of the axis of rotation by means of respective magnetic bearing devices 4, 5. Preferably, it or also the drum 3 is mounted in this way at the two axial ends. The separator insert II has rotor units 4b, 5b of the magnetic bearing devices 4, 5. In contrast, stator units 4a, 5a of the magnetic bearing devices 4, 5 are arranged on the frame I-1.

The magnetic bearing devices 4, 5 preferably act radially and axially and preferably hold the rotor 2 in suspension in the housing 1 at a distance from the latter.

In this context, the rotor units 4b, 5b can be designed essentially in the manner of inner rings made of magnets, in particular permanent magnets, and the reusable stator units 4a, 5a, can be designed essentially in the manner of outer rings used for axial and radial bearing of the rotor 2 (e.g., at the top) or alternatively also for rotary drive (e.g., at the bottom).

Thus, the rotor units 4b and/or 5b, as part of the separator drive, also constitute part of the rotating system or rotor. In other words, the rotor of the drive is thus a part of the drum of the centrifugal separator.

One or both of the magnetic bearing devices 4, 5 is/are thus preferably also used in addition as a drive device for rotating the rotor 2 with the drum 3 in the housing 1. In this case, the respective magnetic bearing device forms a combined magnetic bearing and drive device. The magnetic bearing devices 4, 5 can be designed as axial and/or radial bearings, which support the drum 3 at its ends during operation in an overall cooperating axial and radial manner and hold it suspended and rotate it overall during operation.

The magnetic bearing devices 4 and 5 can have the same or largely the same basic design. In particular, only one of the two magnetic bearing devices 4, 5 can also be used as a drive device. Corresponding components of the magnetic bearings 4, 5 are thus formed in each case on the separator insert II—on its rotor 2—and other corresponding parts on the frame I. One or both stator units 4a, 5a can also be electrically connected to control and power electronics for driving the electromagnetic components of the magnetic bearing devices.

The respective magnetic bearing device 4, 5 can, for example, operate according to a combined electro-magnetic and permanent-magnetic principle.

Preferably, at least the lower axially acting magnetic bearing device 5 serves to keep the rotor 2 axially suspended within the housing 1 by levitation. It can have one or more first permanent magnets, for example on the underside of the rotor, and further have electromagnets on a holder on the frame which coaxially surround the permanent magnet or magnets. The drive of the rotor can be achieved electromagnetically. However, a drive via rotating permanent magnets can also be realized.

Such bearing and drive devices are used, for example, by the company Levitronix for driving centrifugal pumps (EP2 273 124 B1). They can also be used within the scope of this specification. For example, a first Levitronix motor “bottom” can be used as the drive, which at the same time magnetically supports the drum radially and axially. In addition, a second Levitronix motor—for example identical in construction except for the control in operation—can be provided, which as the magnetic bearing 4 can radially and axially support the rotor 2 at the head.

The rotor speed can be variably adjusted with the aid of a control device 37 (see FIG. 1 or 2) or a separate control device for the magnetic bearings 4, 5. Likewise, the direction of rotation of the rotor 2 can be specified and changed in this way.

During operation, the rotor 2 rotates, thus being held axially in suspension and radially centered. Preferably, the rotor 2 is operated with the drum 3 at a speed of between 1,000, preferably 5,000 to 10,000, and possibly also up to 20,000 revolutions per minute. The centrifugal forces generated as a result of the rotation lead to the separation of a suspension to be processed into different flowable phases LP, HP of different density, as already described above, and to their discharge, as described in more detail below. The product batch is processed in continuous operation, which means that the phases separated from the suspension are completely discharged from the drum again during operation.

This makes it very possible to create a separator insert and housing for a separator that can be designed for single use, which in turn is of particular interest and advantage for the processing of pharmaceutical products such as fermentation broths or the like, since after operation for processing a corresponding product batch in preferably continuous operation during the processing of the product batch, no cleaning of the drum needs to be carried out, since the entire separator insert can be replaced. Optionally, individual elements such as magnets can be suitably recycled (see also DE 10 2017 128 027 A1).

The housing 1 is preferably made of a plastic or plastic composite material. The housing 1 can be cylindrical and have a cylindrical outer jacket, at the ends of which two radially extending boundary walls 6, 7 (cover and base) are formed.

The drum 3 is used for centrifugal separation of a flowable suspension S in a centrifugal field into at least two phases LP, HP of different density, which may be, for example, a lighter liquid phase and a heavy solid phase or a heavy liquid phase.

In a preferred design, the rotor 2 and its drum 3 have a vertical axis of rotation D. However, the housing 1 and the rotor 2 could also be oriented differently in space. The following description refers to the vertical orientation shown (FIG. 3). In case of a different orientation in space, the alignments change according to the new orientation. In addition, one or both outlets—to be discussed—may optionally be arranged differently.

The rotor 2 of the separator with the drum is preferably made entirely or predominantly of a plastic material or of a plastic composite material.

The drum 3 is preferably of cylindrical and/or conical design, at least in sections. The same applies to the other elements in the rotor 2 and on the housing 1 (except for elements of the magnetic bearing devices 4, 5).

The housing 1 is designed in the manner of a container, which is advantageously hermetically closed except for some openings/opening areas (to be discussed).

According to FIGS. 1 and 2, one of the openings is formed in each of the two axial boundary walls 6, 7, which are located here exemplarily at the top and bottom, of the container 1.

According to FIGS. 1 and 2, one of the openings—in the first, here upper axial boundary wall 6—enables or serves as a supply opening 8 for feeding a suspension to be separated in the centrifugal field into at least two phases of different density—LP and HP—through the housing 1 into the drum 3.

Here, the first phase is a lighter phase LP and the second phase is a denser, heavier phase HP compared to the first phase.

A second of the openings—in the second, here lower, axial boundary wall 7—allows or serves as a discharge for the second heavier phase HP directly from the drum 3 through the housing 1.

The drum 3 also has openings, each of which is functionally associated with the openings of the housing.

A feed pipe 12 for a suspension to be processed extends into an upper opening 12a at one axial end of the drum 3. This passes through the housing 1, in particular its one—here upper—axial boundary wall 6. At the outer circumference, the feed pipe 12 is inserted into the housing 1 in a sealed manner according to FIG. 1—e.g., by welding or bonding—or, optionally, is designed integrally with the housing as a plastic injection-molded part. It is preferably also made of plastic. The feed pipe 12 protrudes outwardly from the housing 1 at the top with one end and extends through the upper boundary wall 6 into the drum 3, but does not touch the drum 3. The feed pipe 12 is thus an opening of the housing 1, which is functionally associated with the opening 12a of the drum 3.

According to FIG. 1 (but also FIG. 2), the feed pipe 12 passes concentrically to the axis of rotation of the rotor 2 through the housing 1 and the one magnetic bearing 4, then extends axially within the housing 1 further into the rotatable drum 3 and ends there with its other end—a free outlet end.

According to FIGS. 1 and 2, the feed pipe 12 opens in each case in the drum 3 in a distributor 13 that can rotate with the drum 3. The distributor 13 has a tubular distributor shaft 14 and a distributor foot 15. One or more distributor channels 16 are formed in the distributor foot 15. A separator disk stack consisting here of conical separator disks 17 can be placed on the distributor 13. The distributor 13 and the separator disks 17 are preferably also made of plastic.

In addition, according to both FIG. 1 and FIG. 2, a first peeling disk 33 serves to discharge the heavier phase HP of the two phases HP and LP from the drum 3. A peeling disk shaft or central discharge pipe 34 thereby passes through the second axial boundary wall 7 (see FIG. 1 and FIG. 2) of the housing 1, thus forming a further opening of the housing 1. It also protrudes downward from a lower axial opening 34a of the drum, but does not touch the drum.

According to a possible—but not mandatory—design, the drum 3 here has at least two cylindrical sections 18, 19 of different diameter. Adjacent to these, one or more conical transition areas can be formed on the drum 3. The drum 3 can also be of single or double conical design overall in its central axial region on the inside (not shown here).

As shown, the drum 3 may have a lower cylindrical section 20 of smaller diameter, on/in which the rotor unit 5b of the lower magnetic bearing is also formed, which merges into a conical section 20a, then here for example a cylindrical section 19 of larger diameter, then again a conical section 18a and then an upper cylindrical section 18 of smaller diameter, on which the rotor unit 4b of the upper magnetic bearing 4 is formed.

With regard to the discharge of the lighter phase, the separator inserts of FIGS. 1 and 2 differ from each other.

According to FIG. 1, openings (which can be provided on the drum 3 in a circumferentially distributed manner, wherein several openings can thus be provided on the drum 3 in each case) serve as radial or tangential outlets 21 of the light phase LP from the drum 3. According to the exemplary embodiment of FIG. 1, an opening in the housing outer jacket then enables the outlet or serves as a discharge 10 of the lighter product phase LP formed during the centrifugal separation, which has been discharged from the drum 3.

The first outlets 21 on the radius ro of the drum 3 are designed in particular as “nozzle-like” openings in the outer jacket of the drum 3. They are also designed as so-called “free” outlets from the drum 3. Here, the first outlets 21 serve to discharge the lighter phase LP. This phase exiting the drum 3 is collected in the housing 1 in an upper trapping ring chamber 23 of the housing 1. This trapping ring chamber 23 is configured such that the phase trapped therein is directed to the discharge 10 of the trapping ring chamber 23. This can be achieved by the discharge 10 being located at the lowest point of the trapping ring chamber 23. The trapping ring chamber 23 is open radially inwards towards the rotating drum 3 and is spaced in such a way that liquid spraying out of the respective outlet 21 is essentially only sprayed into the associated trapping ring chamber 23—which is at the same axial level—during centrifugal separation.

A chamber 25 not serving to discharge a phase can optionally be formed below the trapping ring chamber 23. This chamber 25 can optionally have a leakage drain (not shown here).

The first trapping ring chamber 23 and the chamber 25 may be separated from each other by a first wall 26, which is conical in this case and extends inwardly as well as upwardly from the outer casing of the housing 1 and ends radially in front of the drum 3 at a distance therefrom.

Preferably at the lowest point of the trapping ring chamber, the product phase LP is discharged from the housing 1 through the discharge 10. Connectors can be provided on the outside of the housing 1 in the area of the discharge 10 in order to be able to easily connect lines and the like.

These can in turn be formed directly with or adhesively attached to the housing 1. The nozzles are preferably also made of plastic. The housing 1 can be composed of several plastic parts, which are sealed together, for example, by adhesive bonding or welding.

According to FIGS. 1 and 2, the first peeling disk 33 is provided as the (here second) outlet for the heavier phase HP from the drum (through the housing 1), which extends essentially radially and merges into an axially extending discharge pipe 34 as the peeling disk shaft, which passes through the lower axial boundary wall 7 of the housing 1. The peeling disk 33 has an outer diameter ru. Here, ru>ro applies. The inlet openings 33a of the peeling disk 33 thus lie on a larger diameter or radius ru than the outlets 21 for the light phase LP on the radius ro. This makes it possible to use the peeling disk 33 to discharge a heavier phase HP from the drum 3 relative to the lighter phase LP. The peeling disk 33 is stationary during operation of the separator and dips with its outer edge into the heavier phase HP rotating in the drum 3.

The phase HP is diverted inwards through the channels in the peeling disk 33. The peeling disk 33 thus serves to discharge the phase HP in the manner of a centripetal pump.

The peeling disk 33 can be arranged in a simple and compact manner in the drum 3 below the distributor 14 and below the disk stack 17. The radius ru corresponds to the immersion depth of the peeling disk 33.

The discharge pipe 34 is guided with one end out of the housing 1 downwards out of the drum and through the lower boundary wall 7, but does not touch the drum 3. The discharge pipe 34 can be formed integrally with the housing 1 or be inserted into it in a sealed manner. A hose or the like can be connected to the discharge pipe as a discharge line 35.

The discharge pipe passes through the housing 1 and the lower magnetic bearing 5 concentrically to the axis of rotation D of the rotor 2, then extends axially further within the housing 1 into the peeling disk 33.

It can be provided that a controllable, in particular electrically controllable, regulating valve 36 is inserted into the outlet for the heavy phase HP, in particular into the discharge line 35 for the heavier phase HP. By means of the regulating valve 36, the volumetric flow of the heavy phase HP in the discharge 35 can be throttled and the immersion depth of the associated peeling disk can be increased. A control device 37 is preferably provided. The regulating valve 36 is preferably connected to the control device 37 in a wireless or wired manner.

The control device 37 may also be designed and provided for controlling the magnetic bearings 4, 5 and the drive.

According to FIG. 2, the light phase LP is also discharged via a peeling disk.

For this purpose, a second peeling disk 22 is provided in the upper area of the drum 3 here, the inlet openings 22a of which can again be located at a smaller radius ro than the radius ru of the inlet of the first—lower—peeling disk 33 for the heavier phase.

The shaft of this second peeling disk 22 can surround the feed pipe 8 in the manner of an annular channel like an outer discharge pipe 24 and be tightly connected to the housing 1 instead of the feed pipe 8 or be formed integrally therewith. Thus, according to FIG. 2, the discharge pipes 24, 34 of the two peeling disks 22, 33 are led out of the drum 3 at opposite ends thereof. They are further led out of the housing 1 at opposite ends thereof. They may be inserted in the housing 1 in a sealed manner. However, they may also be integrally made with the latter from plastic. The feed pipe 12 may be connected to the peeling disk shaft 24 at the upper end thereof. A radial or tangential connecting nozzle 24a may extend from the peeling disk shaft 24. A discharge line 40 for discharging the light phase can be connected to this, which can open into a bag or tank the like, for example. Accordingly, the ends of the pipes 12 and 34 can also be designed as nozzles for connecting hoses or the like (FIG. 2, but also FIG. 1).

It may be provided that a controllable, in particular electrically controllable, regulating valve 39 is also inserted into the discharge line 40 for the light phase LP.

By means of the regulating valve 39, the volume flow of the light phase LP can be changed, in particular throttled more or less, and thus the immersion depth of the second peeling disk 22 can be changed. The regulating valve 39 is also connected to the control device 37 in a wireless or wired manner, so that it can be controlled by the control device 37.

The respective peeling disk 22, 33 is in each case a cylindrical and essentially radially aligned disk provided with a plurality of channels, for example with one to six, which is stationary in operation and has channels, so that a kind of centripetal pump is formed. The respective peeling disk 22 or 33 dips with its outer edge into the phase LP or HP rotating in the separator. Through the channels in the peeling disk, the respective phase LP, HP is diverted inwards and the rotational speed of the respective phase LP, HP is converted into pressure. The respective peeling disk 22, 33 thus replaces a discharge pump for the respective phase LP, HP. The peeling disks thus each operate as a centripetal pump. They can be made of plastic.

Theoretically, a third peeling disk could also be provided, which could be used to derive a further phase.

In the following, the operation of the separators according to FIG. 1 and then according to FIG. 2 will be briefly described.

First, the respective separator with its reusable components is provided. These include the frame I and the drive and stator units 4a, 5a of the magnetic bearing devices. This also includes a control unit 37. A separator insert II is then provided and mounted on the frame I. The stator units 4a, 5a and 5a must be removed from the separator. For this purpose, only the stator units 4a and 5a have to be moved apart. The separator insert is then positively inserted and the stator units are moved towards each other. This holds the housing securely against rotation. Optionally, hoses are now connected to the nozzles, which open into tanks or bags. The respective separator insert of FIGS. 1 and 2 can therefore preferably at least also have hoses and nozzles which can be connected to further lines (not shown here) as well as containers such as bags, tanks, pumps and the like.

Then, after connecting the pipes and hoses and the like, a suspension is fed into the rotating drum (supply opening 8) and separated there centrifugally into the light phase LP and the heavy phase HP.

The heavier phase HP of greater density flows radially outward in the drum 3 in the separation chamber. There, the phase HP leaves the drum on a radius ru through the channels of the stationary peeling disk 33.

The lighter phase LP flows radially inward in the drum 3 in the separation chamber and rises upward through a channel 38 on a shaft of the distributor. There, the phase LP leaves the drum at a radius ro as shown in FIGS. 1 and 2.

The regulating valve(s) 36, 39 can be used to influence the separation process in a simple manner. This results in an optimization of the separation process.

The main application of the separator according to the invention is cell separations in the pharmaceutical industry. The performance range is intended for processing of broths from fermenters in the range of 100 L-4000 L as well as for laboratory applications.

Other areas of industry in which separators are used would also be conceivable: Chemical, pharmaceutical, dairy technology, renewable raw materials, oil and gas, beverage technology, mineral oil, etc.

The separators shown enable the production of a separator insert in which preferably all components in contact with the product can be made of plastic or other non-magnetic materials, which can be disposed of after single use or fed into a recycling process. Cleaning after use is thus not necessary. The separator and its operation can thus be implemented cost-effectively.

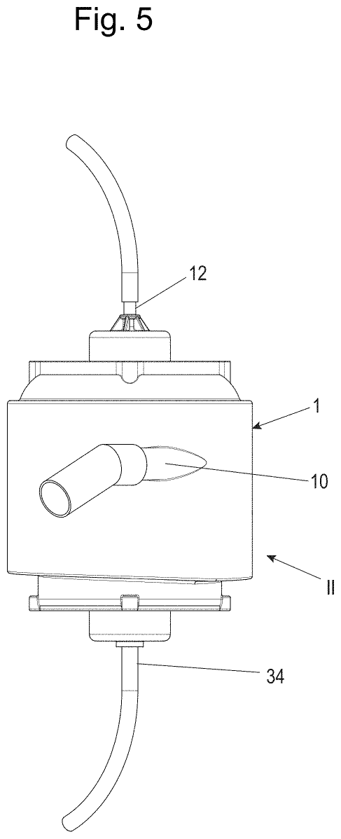

FIG. 5 shows a variation of a separator insert II of FIG. 4 in a second embodiment variant, wherein identical features are provided with analogous reference signs. The special feature of this second embodiment variant is that the interlocking elements 41b and the corresponding interlocking elements 41a provided on the frame I exist only on one side between the frame I and the housing of the separator insert II, thereby also enabling axial and torsional locking of the separator insert II relative to the frame I. Among other things, this reduces the complexity of the structure.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

Frame I
Console I-1
Carriage I-2
Rollers I-3
Receptacles I-4, I-5
Separator insert II
Housing 1
Rotor 2
Drum 3
Magnetic bearing devices 4, 5
Stator units 4a, 5a
Rotor unit 4b, 5b
Radial boundary wall 6, 7
Supply opening 8
Discharge 10
Feed pipe 12
Opening 12a
Distributor 13
Distributor shaft 14
Distributor foot 15
Distributor channel 16
Separator disk 17
Cylindrical sections 18, 19, 20
Conical sections 18a, 20a
Outlets 21
Peeling disk 22
Inlet openings 22a
Trapping ring chamber 23
Discharge pipe 24
Connecting nozzle 24a
Chamber 25
Conical wall 26
Peeling disk 33
Inlet openings 33a
Discharge pipe 34
Opening 34a
Discharge line 35
Regulating valve 36
Control device 37
Channel 38
Regulating valve 39
Discharge line 40
Interlocking elements 41
Pins 41a
Recesses 41b
Interlocking elements 42
Axis of rotation D
Suspension S
Phases LP, HP
Radii ro, ru

1-23. (canceled)

24. A separator insert for a separator configured to separate a flowable suspension in a centrifugal field into at least two flowable phases of different density, the separator insert comprising:
a) a housing, which is stationary in operation, wherein the housing is a container that is closed except for
a supply opening in a first axial boundary wall of the housing and configured to receive an inflowing suspension; and
two discharge openings for the at least two flowable phases of different density, wherein the two discharge openings are formed on
an outer casing of the housing and a second axial boundary wall of the housing, or
the first and the second axial boundary wall of the housing;
b) a rotor, which is rotatable about an axis of rotation, arranged within the housing, wherein the rotator comprises a drum, which has multiple openings comprising
an opening at a first of two axial ends of the drum into which a feed pipe, which does not rotate during operation of the separator, extends to feed the suspension to be processed in the drum, wherein the feed pipe does not touch the drum;
at least one outlet at a second of the two axial ends of the drum into which a discharge pipe, which does not rotate during operation of the separator, extends, wherein the discharge pipe is part of a first peeling disk, which does not rotate during operation of the separator and which is arranged in the drum;
d) a separator arranged in the drum; and
e) at least two rotor units for magnetic bearing devices, wherein the at least two rotor units are arranged at two axially spaced locations of the rotor, and wherein the at least two rotor units are configured to hold the rotor in a suspended state, to rotatably mount the rotor, and to rotate the rotor within the housing during operation of the separator.

25. The separator insert of claim 24, wherein the drum includes further openings that are free radial outlets for a second of the flowable phases from the drum into the housing, from which the second of the flowable phases can be discharged.

26. The separator insert of claim 25, wherein the free outlets are associated with a trapping ring chamber of the housing, which has a discharge from the housing.

27. The separator insert of claim 24, further comprising a second peeling disk.

28. The separator insert of claim 27, wherein the second peeling disk comprises a peeling disk shaft formed as a second discharge pipe, wherein the peeling disk shaft is arranged coaxially with the feed pipe and is guided coaxially therewith out of the drum and through the supply opening in the first axial boundary wall of the housing.

29. The separator insert of claim 27, further comprising:
a regulating valve connected on a flow side downstream of the first peeling disk.

30. The separator insert of claim 29, further comprising:
a second regulating valve connected on a flow side downstream of the second peeling disk.

31. The separator insert of claim 24, wherein the separator insert is a pre-assembled, exchangeable unit configured for insertion into a frame of the separator.

32. The separator of claim 24, wherein the housing and the drum are made entirely or predominantly of plastic or a plastic composite material.

33. The separator insert of claim 24, wherein the at least two rotor units are respectively arranged at the two axial ends of the drum, and wherein the feed pipe and the discharge pipe of the first peeling disk each pass axially through one of the at least two rotor units.

34. The separator insert of claim 24, wherein one or both of the magnetic bearing devices are configured to rotate and adjust a speed of the speed of the drum, and wherein one or both of the magnetic bearing devices act in a radially and axially bearing manner and keep the rotor suspended in the drum at a distance from the drum during operation.

35. A separator insert of claim 24, wherein the separator arranged on the drum is a stack of separator disks arranged in the drum, and wherein the first peeling disk is arranged in the drum below a distributor and below the stack of separator disks.

36. A separator insert of claim 24, wherein all components of the separator insert are assembled into the pre-assembled unit, wherein all of the product-contacting elements of the separator insert are made of plastic or other non-magnetic material.

37. The separator insert of claim 24, wherein the feed pipe and the discharge pipe project outwardly from the housing as nozzles that are connected to the housing in a sealed manner or are formed integrally with the housing.

38. The separator insert of claim 24, wherein the housing is hermetically closed except for the supply opening and the two discharge openings.

39. A separator configured to separate a flowable suspension in a centrifugal field into at least two flowable phases of different density, the separator comprising:
a frame; and
a separator insert exchangeably arranged on the frame, wherein the separator insert comprises
a) a housing, which is stationary in operation, wherein the housing is a container that is closed except for
a supply opening in a first axial boundary wall of the housing and configured to receive an inflowing suspension; and
two discharge openings for the at least two flowable phases of different density, wherein the two discharge openings are formed on
an outer casing of the housing and a second axial boundary wall of the housing, or
the first and the second axial boundary wall of the housing;
b) a rotor, which is rotatable about an axis of rotation, arranged within the housing, wherein the rotator comprises a drum, which has multiple openings comprising
an opening at a first of two axial ends of the drum into which a feed pipe, which does not rotate during operation of the separator, extends to feed the suspension to be processed in the drum, wherein the feed pipe does not touch the drum;
at least one outlet at a second of the two axial ends of the drum into which a discharge pipe, which does not rotate during operation of the separator, extends, wherein the discharge pipe is part of a first peeling disk, which does not rotate during operation of the separator and which is arranged in the drum;
d) a separator arranged in the drum; and
e) at least two rotor units for magnetic bearing devices, wherein the at least two rotor units are arranged at two axially spaced locations of the rotor, and wherein the at least two rotor units are configured to hold the rotor in a suspended state, to rotatably mount the rotor, and to rotate the rotor within the housing during operation of the separator.

40. The separator of claim 39, further comprising:
spaced-apart receptacles with stator units of the bearing devices, between which the separator insert is insertable in a non-rotatable and exchangeable manner.

41. The separator of claim 40, wherein a relative distance of the spaced-apart receptacles with the stator units of the bearing devices is adjustable in order to replace the separator insert.

42. The separator of claim 39, wherein the separator insert is configured to be non-rotatably attached to the frame in a form-fitting or force-fitting manner.

43. The separator of claim 42, wherein the housing and at least one of the spaced-apart receptacles have corresponding interlocking elements to hold the housing non-rotatably on the at least one of the spaced-apart receptacles.

44. The separator of claim 43, wherein the housing and only of the spaced-apart receptacles have corresponding interlocking elements to hold the housing non-rotatably on the only one of the spaced-apart receptacles.

45. The separator of claim 40, wherein the housing and the spaced-apart receptacles have corresponding interlocking elements to hold the housing non-rotatably on the spaced-apart receptacles.

46. The separator of claim 39, further comprising:
a regulating valve coupled to one of the two discharge openings; and
a control device connected to the regulating valve.
